(19) United States
(12) Patent Application Publication
(10) Pub. No.: US 2026/0232155 A1
(43) Pub. Date: Aug. 13, 2026

(54) VACUUM CLEANER

(71) Applicant: LG ELECTRONICS INC., Seoul (KR)

(72) Inventors: Inkyu HWANG, Seoul (KR); Kietak HYUN, Seoul (KR); Jaehun HAN, Seoul (KR); Junhyung LIM, Seoul (KR)

(21) Appl. No.: 19/148,062

(22) PCT Filed: Jun. 28, 2023
(86) PCT No.: PCT/KR2023/009023

§ 371 Date: Jul. 15, 2025

(30) Foreign Application Priority Data
Jun. 7, 2023 (KR) 10-2023-0072867

(51) Int. Cl. A47L 9/16; B04C 5/13; B04C 5/185; B04C 5/26; B04C 5/28

(52) U.S. Cl. CPC A47L 9/1608; A47L 9/1625; A47L 9/1641; A47L 9/165; B04C 5/13; B04C 5/185; B04C 5/26; B04C 5/28

(57) ABSTRACT

The embodiments of the present disclosure may relate to a cleaner that includes a suction port configured to guide air into a dust bin; a first cyclone part configured to separate dust from air sucked in through the suction port; and a second cyclone part configured to separate dust from air discharged from the first cyclone part, and the second cyclone part may include a plurality of cyclone bodies each having an inlet configured to receive air discharged from the first cyclone part; a vortex finder having at least a portion disposed on the inside of each cyclone body; and a band member disposed to surround an outer surface of each vortex finder and configured to guide air discharged from the first cyclone part to the inside of each cyclone body, and the gap between the band member and each inlet may increase from the center of the band member toward the periphery of the above band member.

### BACKGROUND

### Technical Field

Embodiments of the present disclosure relate to a cleaner.

### Background of the Disclosure

Generally, a cleaner is an electrical appliance configured to suck in small pieces of trash or dust by sucking air and filling a dust bin provided therein, and is commonly called a vacuum cleaner.

Such vacuum cleaners may be classified into manual cleaners that perform cleaning while the user moves the cleaner, and automatic cleaners that perform cleaning while driving on their own. The manual vacuum cleaners may be classified into canister type vacuum cleaners, upright type vacuum cleaners, handheld vacuum cleaners and stick type vacuum cleaners, depending on the shape In the past, canister-type vacuum cleaners were widely used for home vacuum cleaners, but recently, handheld vacuum cleaners stick type vacuum cleaners, which can a dust bin and vacuum cleaner body as one unit to improve convenience, are being widely used.

A canister-type vacuum cleaner has a cleaner body and a suction inlet that are connected by a rubber hose or pipe, and in some cases, a brush may be fitted to the suction inlet for use.

A hand vacuum cleaner is designed to maximize portability. The hand vacuum cleaner is light in weight but short in length, so the cleaning area may be limited when sitting down. Accordingly, it is used to clean localized areas such as a desk, sofa or inside a car.

A stick vacuum cleaner may be used standing up so a user can clean without bending down. This makes the stick vacuum cleaner ideal for cleaning wide areas while moving around. While the hand vacuum cleaner can clean narrow spaces, the stick vacuum cleaner can clean wider spaces and high places that are hard to reach. Recently, the stick vacuum cleaner is being provided in modular form, allowing user to actively change the vacuum cleaner type for user on various cleaning targets.

Cyclones used in vacuum cleaners may be classified into vertical cyclones and axial cyclones depending on the direction of air inflow.

The structure of the vertical cyclone may be found in Korean Patent Publication No. 10-0673769 (hereinafter, Patent Document 1). According to the disclosure in Patent Document 1, a vertical cyclone is provided with a vertical guide to form a spiral flow. In the case of the vertical cyclone, air is introduced in the vertical direction of the outer surface through structures such as the vertical guide, and the spiral flow is formed by a structure that introduces air in the vertical direction. The vertical cyclone has the advantage of a simple structure and is advantageous in that it is suitable for installation in a limited space such as a vacuum cleaner because it is advantageous in a circular arrangement. However, the vertical cyclone has a disadvantage in that a large pressure loss occurs due to a high-speed flow that is eccentric to one side.

The structure of the axial cyclone may be found in Korean Patent Publication No. 10-2008-0108284 (hereinafter, Patent Document 2). According to the disclosure in Patent Document 2, the axial cyclone is provided with a spiral ramp for forming a spiral flow. In the case of the axial cyclone, the flow is introduced in the axial direction, and the axial cyclone is configured to generate a swirling flow by using a spiral ramp, etc. The axial cyclone has the advantage of an appropriate flow velocity and uniform suction compared to a tangential inflow cyclone, and thus has the advantage of low pressure loss. On the other hand, the axial cyclone has the disadvantage of being difficult to manufacture a guide vane.

In order to improve the overall efficiency of the cleaner by reducing pressure loss as much as possible, it is desirable to use an axial cyclone. However, conventional cleaners using the axial cyclone had the following problems.

First, conventional vacuum cleaners with multiple axial cyclones are made by gathering multiple axial cyclones that are manufactured separately to separate dust. The axial cyclones are manufactured separately in molds of the same shape so that they have the same shape.

At this time, if the axial cyclones have the same shape, most of the air flowing in from the outside flows into the axial cyclones located on the outer side of the multiple axial cyclones, forming a cyclone flow. In this case, since the air does not flow into the axial cyclone located in the center, there was a problem that the air flow passing through the axial cyclone was formed unevenly, and the overall efficiency of the axial cyclone was reduced.

### DETAILED DESCRIPTION OF THE INVENTION

### Technical Problems

Accordingly, one object of the present disclosure is to solve the above-noted disadvantages of the prior art, and to provide a cleaner that may improve the overall flow efficiency of an axial cyclone by allowing air to flow into the central axial cyclone among multiple axial cyclones.

Another object of the present disclosure is to provide a cleaner that may enable miniaturization and weight reduction of the entire axial cyclone.

A further object of the present disclosure is to provide a cleaner that may stabilize the uneven flow of air passing through an axial cyclone.

### Technical Solution

To solve the objects of the present disclosure, a cleaner according to embodiments may include a suction port configured to guide air into a dust bin; a first cyclone part configured to separate dust from air sucked in through the suction port; and a second cyclone part configured to separate dust from air discharged from the first cyclone part. The second cyclone part may include a plurality of cyclone bodies each having an inlet configured to receive air discharged from the first cyclone part; a vortex finder having at least a portion disposed on the inside of each cyclone body; and a band member disposed to surround an outer surface of each vortex finder and configured to guide air discharged from the first cyclone part to the inside of each cyclone body, and the gap between the band member and each inlet may increase from the center of the band member toward the periphery of the above band member.

To solve the objects of the present disclosure, a cleaner according to embodiments may include a suction port configured to guide air into a dust bin; a first cyclone part configured to separate dust from air sucked through the suction port; and a second cyclone part configured to separate dust from air discharged from the first cyclone part, and the second cyclone part may include a plurality of cyclone bodies each forming an outer wall around a hollow portion; a vortex finder having at least portion disposed on the inner side of each cyclone body; and a band member disposed to surround an outer surface of each vortex finder and configured to form a guide path to guide air discharged from the first cyclone part to the inner side of each cyclone body, and the cross-sectional area of the guide path may increase from the center of the band member toward the outside of the band member.

The band member may be formed with an upward slope from the inside to the outside.

The second cyclone part may further include a plate member arranged to surround an outer surface of each cyclone body; and a fixing member configured to fix the plate member to the band member, and the plurality of cyclone bodies may be arranged radially around the fixing member.

The axial length of each vortex finder may gradually increase as it is positioned farther away from the fixed member.

The heights of the cyclone bodies may be the same.

To solve the objects of the present disclosure, a cleaner according to embodiments may include a suction port configured to guide air into a dust bin; a first cyclone part configured to separate dust from air sucked in through the suction port; and a second cyclone part configured to separate dust from air discharged from the first cyclone part, and the second cyclone part may include a plurality of cyclone bodies each having an inlet configured to receive air discharged from the first cyclone part; a vortex finder having at least a portion disposed on the inside of each cyclone body; a band member disposed to surround an outer surface of each vortex finder and configured to guide air discharged from the first cyclone part to the inside of each cyclone body; and a frame member formed to surround the band member and configured to guide air discharged from the first cyclone part together with the band member to the inside of each cyclone body, and the gap between the frame member and each inlet may increase from the inside to the outside of the frame member.

The frame member may be formed with an upward slope from the inside to the outside.

The gap between the band member and each inlet may be the same.

The second cyclone part may further include a protruding member disposed on an upper side of the band member and configured to guide air passing through the vertex finder to flow upward.

### Advantageous Effects

As described above, according to the cleaner according to the embodiments of the present disclosure, air may be introduced to the axial cyclone located at the center among the plurality of axial cyclones, so there is an effect of improving the overall flow efficiency of the axial cyclone.

Furthermore, the cleaner according to the present disclosure has the effect of reducing the length of the axial cyclone located at the center, thereby miniaturizing and reducing the weight of the entire axial cyclone.

Still further, the cleaner according to the embodiments of the present disclosure has the effect of stabilizing the uneven flow of air passing through the axial cyclone by allowing air to flow into the axial cyclone located at the center due to a structure in which the flow path becomes narrower as it goes inward.

### DESCRIPTION OF DRAWINGS

FIGS. 1 and 2 are diagrams to describe a cleaner in a cleaner system according to embodiments of the present disclosure;

FIG. 3 is a diagram to describe a lower surface of a dust bin of a cleaner according to embodiments of the present disclosure;

FIG. 4 is an exploded view of a cleaner according to embodiments of the present disclosure;

FIG. 5 is a perspective view of a second cyclone unit according to a first embodiment of the present disclosure;

FIG. 6 is a plane view of FIG. 5;

FIG. 7 is a cross-sectional view cut away along 1-1 line of FIG. 6;

FIG. 8 is a perspective view of a second cyclone unit according to a second embodiment of the present disclosure;

FIG. 9 is a plane view of FIG. 8;

FIG. 10 is a cross-sectional view cut away along 2-2 line of FIG. 9; and

FIG. 11 is a diagram to describe the shape of a filter according to a second embodiment of the present disclosure.

### DESCRIPTION OF SPECIFIC EMBODIMENTS

Description will now be given in detail according to exemplary embodiments disclosed herein, with reference to the accompanying drawings.

The present disclosure may be variously modified and may have various embodiments, and particular embodiments illustrated in the drawings will be specifically described below. The description of the embodiments is not intended to limit the present disclosure to the particular embodiments, but it should be interpreted that the present disclosure is to cover all modifications, equivalents and alternatives falling within the spirit and technical scope of the present disclosure.

Terminology that is used in the present disclosure is limited to only for embodiments herewith but made only to make it easy to understand the present disclosure.

Terms of respective elements used in the following description are terms defined taking into consideration of the functions obtained in the present invention. Therefore, these terms do not limit technical elements in the present invention. Further, the defined terms of the respective elements will be called other terms in the art.

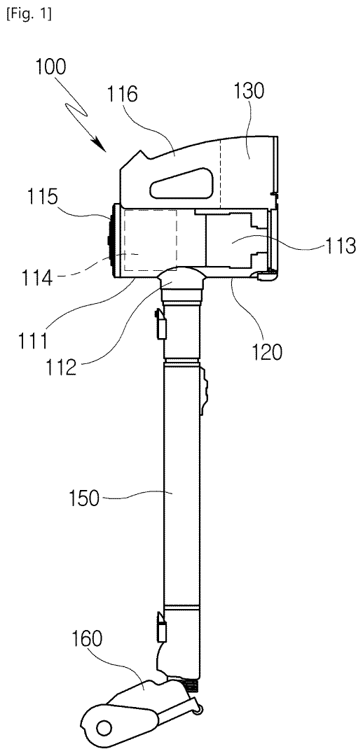

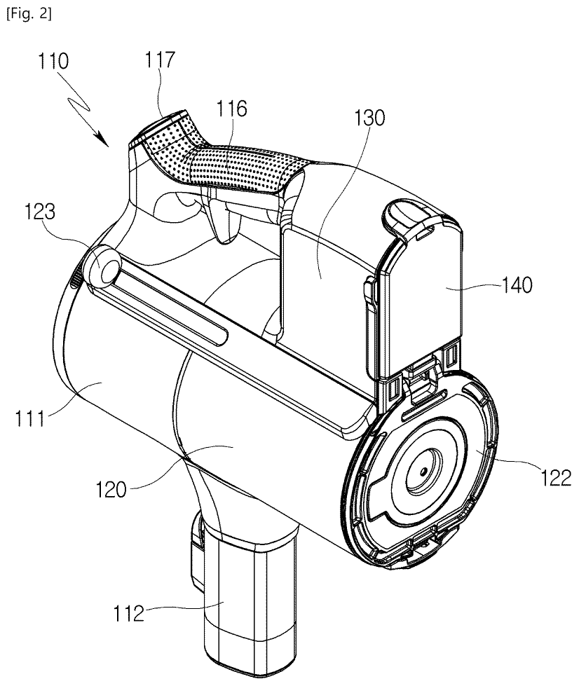

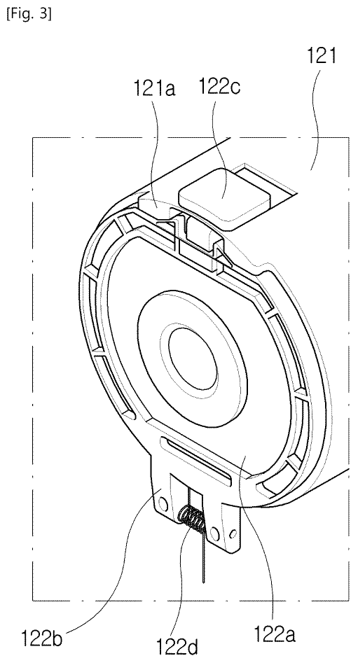

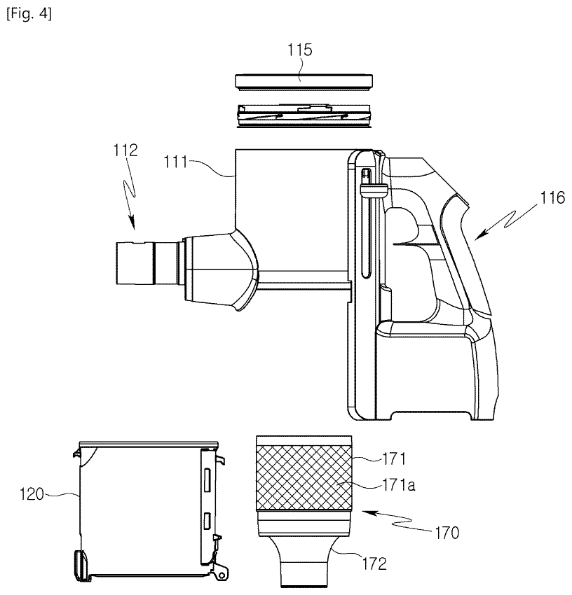

FIGS. 1 and 2 are diagrams to describe a cleaner in a cleaner system according to embodiments of the present disclosure. FIG. 3 is a diagram to describe a lower surface of a dust bin of a cleaner according to embodiments of the present disclosure. FIG. 4 is an exploded view of a cleaner according to embodiments of the present disclosure.

Referring to FIGS. 1 to 4, the structure of the cleaner 100 will be described as follows.

The cleaner 100 may mean a vacuum cleaner that is manually operated by a user. For example, the cleaner 100 may mean a hand vacuum cleaner or a stick vacuum cleaner.

Meanwhile, in one embodiment of the present invention, the direction of the cleaner 100 may be defined based on the time when the bottom surface (lower surface) of a dust bin 120 and a battery housing 130 are placed on the ground.

At this time, the front or forward may refer to the direction in which a suction port 112 is arranged based on a suction motor 114, and the rear or rearward may refer to the direction in which a handle 116 is arranged based on the suction motor 114. In addition, the direction in which the suction port 112 is arranged on the right side when viewed from the suction motor 114 may be referred to as the right side, and the direction in which the suction port 112 is arranged on the left side may be referred to as the left side. In addition, in one embodiment of the present invention, the upper and lower sides or upward and downward may be defined along the direction perpendicular to the ground when the bottom surface (lower surface) of the dust bin 120 and the battery housing 130 are placed on the ground.

The cleaner 100 may include a cleaner body 110. The cleaner body 110 may include a cleaner body housing 111, a suction port 112, a first cyclone part 113, a suction motor 114, an air discharge cover 115, a handle 116, and a manipulation part 117.

The cleaner body housing 111 may form the exterior of the cleaner 100. The cleaner body housing 111 may provide a space that may accommodate the suction motor 114 and a filter (not shown) inside. The cleaner body housing 111 may be configured in a shape similar to a cylinder.

The suction port 112 may protrude outwardly from the cleaner body housing 111. For example, the suction port 112 may be formed in a cylindrical shape with an open interior. The suction port 112 may be coupled to an extension pipe 150. The suction port 112 may provide a path through which air containing dust may flow. The suction port 112 may be connected to the cleaner body 110 so that its central portion is located roughly at the boundary between the dust bin 120 and the cleaner body housing 111.

Meanwhile, in this embodiment, a virtual line penetrating the inside of the suction port 112 configured in a cylindrical shape may be formed. At this time, the virtual line can mean the longitudinal axis of the suction path.

The cleaner 100 according to the embodiment of the present invention may be provided with at least one cyclone part capable of separating dust by cyclone flow. For example, the cleaner 100 may include a first cyclone part 113 and a second cyclone part 200.

The first cyclone part 113 may be communicated with the suction port 112. The first cyclone part 113 may separate dust sucked into the inside through the suction port 112. The space inside the first cyclone part 113 may be communicated with the space inside the dust bin 120.

The first cyclone part 113 is connected to the suction port 112 and is configured to apply the principle of a dust collector that uses centrifugal force to separate dust sucked into the interior of the cleaner body 110 through the suction port 112. In other words, the first cyclone part 113 refers to a space in which a cyclone flow that rotates along the inner surface of the dust bin 120 occurs, and the first cyclone part 113 may refer to a portion of the space inside the dust bin 120.

The cyclone flow generated in the first cyclone part 113 may be due to the suction force of the suction motor 114.

The cyclone flow generated in the first cyclone part 113 may be formed between the inner circumference of the dust bin 120 and the outer circumference of the filter body 171 described below. That is, the above cyclone flow may be formed inside the first cyclone part 113.

The space inside the first cyclone part 113 may be connected to the suction port 112. The air and dust sucked through the suction port 112 flow along the inner surface of the first cyclone part 113, and thus, a cyclone flow may occur in the inner space of the first cyclone part 113.

For example, the cyclone flow generated in the first cyclone part 113 may be formed to surround the outer perimeter of the filter body 171 in a circular shape. That is, the air sucked through the suction port 112 flows in a circular shape along the outer surface of the filter body 171 based on the central axis of the filter body 171, and thus, a cyclone flow may occur in the inner space of the first cyclone part 113.

Specifically, when the axis of the cyclone flow generated in the first cyclone part 113 is arranged vertically below the direction of gravity, the air sucked through the suction port 112 may flow in a circular shape along the outer surface of the filter body 171 based on the central axis of the filter body 171. Alternatively, when the axis of the cyclone flow generated in the first cyclone part 113 is arranged parallel to the ground, the air sucked through the suction port 112 may flow in a circular shape along the outer surface of the filter body 171 based on the central axis of the filter body 171.

As another example, the cyclone flow generated in the first cyclone part 113 may be formed in a spiral shape along the outer perimeter of the filter body 171. That is, the air sucked through the suction port 112 flows in a spiral manner along the outer circumference of the filter body 171, thereby allowing cyclonic flow to occur in the internal space of the first cyclone part 113. Accordingly, cyclonic flow may occur in the internal space of the first cyclone part 113.

Specifically, when the axis of the cyclone flow generated in the first cyclone part 113 is arranged to be inclined with respect to the ground, the air sucked through the suction port 112 may flow in a spiral shape along the outer circumference of the filter body 171.

The cleaner 100 according to the embodiment of the present invention may include a second cyclone part 200 that re-separates dust from the air discharged from the first cyclone part 113. That is, the second cyclone part 200 may filter out small dust that the first cyclone part 113 and the filter part 170 could not filter out from the air that passed through the first cyclone part 113 and the filter part 170.

At this time, the second cyclone part 200 may be positioned inside the first cyclone part 113 so that the size of the cleaner 100 is minimized. The second cyclone part 200 may be positioned below the suction motor 114. Specifically, the second cyclone part 200 may be positioned inside the filter part 170). That is, the first cyclone part 113 and the second cyclone part 200 may be positioned inside the dust bin 120 with the filter unit 170 between them.

The second cyclone part 200 may include a plurality of cyclone bodies 210 that are positioned in parallel. Therefore, the air discharged from the first cyclone part 113 may pass through the filter part 170 and be divided into a plurality of cyclone bodies (210). That is, the cyclone flow generated in the second cyclone part 113 may be formed inside the cyclone body 210.

Meanwhile, the second cyclone part 200 may also include a single cyclone body 210, and in this case, the axis of the cyclone flow generated in the second cyclone part 200 may be extended in the vertical direction.

In addition, the axis of the cyclone flow generated in the first cyclone part 200 may also be extended in the vertical direction. Therefore, the axis of the cyclone flow generated in the first cyclone section 113 and the axis of the cyclone flow generated in the second cyclone part 200 form coaxiality in the vertical direction or be formed in parallel.

A storage member 172 may be placed inside the dust bin 120 to store dust separated from the second cyclone part 200. The storage member 172 may be connected to the lower side of the filter body 171 and may be in contact with the upper surface of the discharge cover 122. In addition, the lower side of the storage member 172 may be opened.

The storage member 172 may divide the space inside the dust bin 120 into a first dust storage where dust separated from the first cyclone part 113 is stored, and a second dust storage where dust separated from the second cyclone part 200 is stored.

Therefore, the space between the storage member 172 and the dust bin 120 may be defined as the first dust storage unit, and the lower internal space of the storage member 172 may be defined as the second dust storage.

The discharge cover 122 may open and close the first dust storage unit and the second dust storage unit together. In other words, the first dust storage unit and the second dust storage unit can be exposed to the outside together.

The suction motor 114 may generate a suction force to suck in air. The suction motor 114 may be accommodated in the cleaner body housing 111. The suction motor 114 may generate a suction force by rotation. For example, the suction motor 114 may be provided in a similar cylindrical shape.

At this time, a cyclone flow may be generated by the suction force of the suction motor 114.

Specifically, when the suction motor 114 is operated, the air sucked through the suction port 112 by the suction force of the suction motor 114 may generate a cyclone flow in the first cyclone part 113 and/or the second cyclone part 200.

Meanwhile, in the present embodiment, a rotation axis of a virtual suction motor may be formed by extending the rotation axis of the suction motor 114.

The suction motor 114 may be located inside the cleaner body housing 111. And, at least a portion of the suction motor 114 may be located above the second cyclone part 200. Therefore, the suction motor 114 may be located above the dust bin 120.

The suction motor 114 may be connected to the outlet 221b of the second cyclone part 200.

The axis of the cyclone flow of the first cyclone part 113 may pass through the suction motor 114.

In an embodiment of the present invention, if the suction motor 114 is located above the second cyclone part 200, the air discharged from the second cyclone part 200 may flow directly toward the suction motor 114, so that the flow path between the second cyclone part 200 and the suction motor 114 may be minimized.

The air discharge cover 115 may be arranged on one side of the cleaner body housing 111 in the axial direction. The air discharge cover 115 may accommodate a filter for filtering air. For example, the air discharge cover 115 may accommodate a HEPA filter.

The air discharge cover 115 may be formed with an air discharge hole for discharging air sucked in by the suction force of the suction motor 114.

A flow guide may be arranged on the air discharge cover 115. The flow guide may guide the flow of air discharged through the air discharge hole.

The handle 116 may be held by a user. The handle 116 may be arranged at the rear of the suction motor 114. For example, the handle 116 may be formed in a shape similar to a cylinder. Alternatively, the handle 116 may be formed in a curved cylinder shape. The handle 116 may be arranged at a predetermined angle with respect to the cleaner body housing 111, the suction motor 114, or the first cyclone part 113.

The handle 116 may include a grip portion formed in a column shape so that the user can hold it, a first extension portion connected to one end of the grip portion in the longitudinal direction (axial direction) and formed to extend toward the suction motor 114, and a second extension portion connected to the other end of the grip portion in the longitudinal direction (axial direction) and formed to extend toward the dust bin 120.

Meanwhile, in the present embodiment, a virtual grip portion penetration line may be formed to extend along the longitudinal direction (axial direction of the column) of the grip portion and penetrate the grip portion.

As an example, the grip portion penetration line may be a virtual line formed inside the cylindrical handle 116 and may be a virtual line formed parallel to at least a portion of the outer surface (outer surface) of the grip portion.

The upper surface of the handle 116 may form a part of the outer appearance of the upper surface of the cleaner 100. This prevents the user's arm from contacting one component of the cleaner 100 when the user grips the handle 116.

The first extension portion may extend from the grip portion toward the cleaner body housing 111 or the suction motor 114. At least a portion of the first extension portion may extend in a horizontal direction.

The second extension portion may extend from the grip portion toward the dust bin 120. At least a portion of the second extension portion may extend in a horizontal direction.

The manipulation part 117 may be placed on the handle 116. The manipulation part 117 may be placed on an inclined surface formed in the upper area of the handle 116. The manipulation part 117 may be composed of a plurality of buttons, and when a user presses a corresponding button, a corresponding command may be executed. The user may input an operation or stop command of the cleaner 100 through the manipulation part 117.

The cleaner 100 may include a dust bin 120. The dust bin 120 may be connected to the suction port 112. The first cyclone part 213 may be located inside the dust bin 120. The dust bin 120 may store dust separated from the first cyclone part 213.

The dust bin 120 may include a dustbin body 121, a discharge cover 122, a dust bin compression lever 123, and a compressor (not shown).

The dust bin body 121 may provide a space for storing dust separated from the first cyclone part 113. For example, the dust bin body 121 may be formed in a similar cylindrical shape.

Meanwhile, in the present embodiment, a virtual dustbin penetration line may be formed that penetrates the internal space of the dust bin body 121 and extends along the longitudinal direction of the dust bin body 121 (meaning the axial direction in the cylindrical dust bin body 121).

The lower surface (bottom surface) of the dust bin body 121 may be partially open. In addition, a lower extension portion 121a may be formed on the lower surface (bottom surface) of the dust bin body 121. The extension portion 121a may be formed to block a portion of the lower surface of the dust bin body 121.

The dust bin 120 may include the discharge cover 122. The discharge cover 122 may be arranged on the lower surface of the dust bin 120.

The discharge cover 122 may be provided to open and close one end of the longitudinal direction of the dust bin body 121. Specifically, the discharge cover 122 may selectively open and close the lower part of the dust bin 120 that opens downward.

The discharge cover 122 may include a cover body 122a and a hinge portion 122b. The cover body 122a may be formed to block a portion of the lower surface of the dust bin body 121. The cover body 122a may rotate downward based on the hinge portion 122b. The hinge portion 122b may be arranged adjacent to the battery housing 130. A torsion spring 122d may be provided in the hinge portion 122b. Therefore, when the discharge cover 122 is separated from the dust bin body 121, the cover body 122a may be supported in a state in which it is rotated by a predetermined angle or more about the hinge portion 122b as an axis in the dust bin body 121 by the elastic force of the torsion spring 122d.

The discharge cover 122 may be coupled to the dust bin 120 through a hook connection. Meanwhile, the discharge cover 122 may be separated from the dust bin 120 through a coupling lever 122c. The coupling lever 122c may be arranged at the front of the dust bin 120. Specifically, the coupling lever 122c may be arranged on the outer surface of the front side of the dust bin 120. When an external force is applied, the coupling lever 122c may elastically deform a hook formed by extending from the cover body 122a to release the hook connection between the cover body 122a and the dust bin body 121.

When the discharge cover 122 is closed, the lower surface of the dust bin 120 may be blocked (sealed) by the discharge cover 122 and the lower extension portion 121a.

The dust bin 120 may include the dustbin compression lever 123 (see FIG. 2). The dust bin compression lever 123 may be arranged on the outside of the dust bin 120. The dust bin compression lever 123 may be arranged to move up and down on the outside of the dust bin 120. The dust bin compression lever 123 may be connected to a compressor (not shown). When the dust bin compression lever 123 moves downward by an external force, the compressor (not shown) may also move downward. Through this, convenience for the user may be provided. The compressor (not shown) and the dust bin compression lever 123 may be returned to their original positions by an elastic member (not shown). Specifically, when an external force applied to the dust bin compression lever 123 is removed, the elastic member may move the dustbin compression lever 123 and the compressor (not shown) upward.

The compressor (not shown) may be placed inside the dust bin body 121. The compressor may move in the internal space of the dust bin body 121. Specifically, the compressor may move up and down inside the dust bin body 121. Through this, the compressor may compress dust inside the dust bin body 121 downward. In addition, when the discharge cover 122 is separated from the dust bin body 121 and the lower portion of the dust bin 120 is opened, the compressor may move from the upper portion of the dust bin 120 to the lower part to remove foreign substances such as residual dust inside the dust bin 120. Through this, the suction power of the cleaner may be improved by preventing residual dust from remaining inside the dust bin 120. In addition, by preventing residual dust from remaining inside the dust bin 120, an unpleasant odor caused by residual substances may be eliminated.

The cleaner 100 may include the battery housing 130. The battery housing 130 may accommodate a battery 140. The battery housing 130 may be arranged on the lower side of the handle 116. For example, the battery housing 130 may have a hexahedral shape with an open bottom. The rear side of the battery housing 130 may be connected to the handle 116.

The battery housing 130 may include a receiving portion that opens downward. The battery 140 may be detached through the receiving portion of the battery housing 130.

The battery housing 130 may be provided with a battery terminal exposed to the outside.

When the battery terminal of the battery housing 130 and the external charging terminal (not shown) are combined, power may be supplied to the battery 140 through the battery terminal. The battery terminal may be arranged spaced apart from each other on the lower side of the battery housing 130.

The cleaner 100 may include the battery 140.

For example, the battery 140 may be detachably coupled to the cleaner 100. The battery 140 may be detachably coupled to the battery housing 130. For example, the battery 140 may be inserted into the inside of the battery housing 130 from the bottom of the battery housing 130. With this configuration, the portability of the cleaner 100 may be improved.

Alternatively, the battery 140 may be integrally provided inside the battery housing 130. At this time, the lower surface of the battery 140 is not exposed to the outside.

The battery 140 may store electric energy and may supply power to each component including the suction motor 114 of the cleaner 100. The battery 140 may be placed at the bottom of the handle 116. The battery 140 may be placed at the rear of the dust bin 120. That is, the suction motor 114 and the battery 140 may be placed so as not to overlap in the vertical direction, and may also be placed at different heights. With respect to the handle 116, the suction motor 114, which is heavy, may be placed in front of the handle 116, and the battery 140, which is light, may be placed below the handle 116, so that the weight of the entire cleaner 100 may be evenly distributed. This may prevent the user's wrist from being strained when the user holds the handle 116 and cleans.

According to an embodiment, when the battery 140 is coupled to the battery housing 130, the lower surface of the battery 140 may be exposed to the outside. When the cleaner 100 is placed on the floor, the battery 140 may be placed on the floor, so that the battery 140 may be separated directly from the battery housing 130. In addition, since the lower surface of the battery 140 is exposed to the outside and comes into direct contact with the external air of the battery 140, the cooling performance of the battery 140 may be improved.

Meanwhile, when the battery 140 is integrally fixed to the battery housing 130, the structure for attaching and detaching the battery 140 and the battery housing 130 may be reduced, so that the overall size of the cleaner 100 may be reduced and its weight can be reduced.

The cleaner 100 may include an extension pipe 150. The extension pipe 150 may be connected to the cleaning module 160. The extension pipe 150 may be connected to the cleaner body 110. The extension pipe 150 may be connected to the suction port 112 of the cleaner body 110. The extension pipe 150 may be formed in a long cylindrical shape.

The cleaner body 110 may be connected to the extension pipe 150. The cleaner body 110 may be connected to the cleaning module 160 through the extension pipe 150. The cleaner body 110 may generate suction force through the suction motor 114 and provide suction force to the cleaning module 160 through the extension pipe 150. External dust may be introduced into the cleaner body 110 through the cleaning module 160 and the extension pipe 150.

The cleaner 100 may include the cleaning module 160. The cleaning module 160 may be connected to the extension pipe 150. Therefore, the outside air can be introduced into the cleaner body 110 of the cleaner 100 through the cleaning module 160 and the extension pipe 150 by the suction force generated in the cleaner body 110 of the cleaner 100.

The cleaner according to one embodiment may include the filter unit 170.

The filter unit 170 may filter air discharged from the first cyclone part 113.

The filter unit 170 may guide air separated from dust in the first cyclone part 113 to the second cyclone part 200. That is, the filter unit 170 may be a mesh filter having a plurality of holes.

The filter unit 170 may include a filter body 171 and a filter hole 171a.

The filter body 171 may be placed inside the dust bin 120. Specifically, the filter body 171 may be disposed inside the first cyclone part 213. The second cyclone part 200 may be disposed inside the filter body 171. That is, the filter body 171 may be provided between the cyclone part 213 and the second cyclone part 200.

The filter body 171 may be formed in a cylindrical shape, although the embodiments are not limited thereto.

The central axis of the filter body 171 may extend in the vertical direction. The central axis of the filter body 171 may extend along the longitudinal direction of the filter body 171.

As an example, the central axis of the filter body 171 may form a coaxial axis with the axis of the cyclone flow generated in the first cyclone part 113. As another example, the central axis of the filter body 171 may be formed parallel to the axis of the cyclone flow generated in the first cyclone part 113.

The filter hole 171a may guide air into the interior of the filter body 171. The plurality of filter holes 171a may be formed in the longitudinal direction along the outer circumference of the filter body 171. The filter hole 171a is a hole having a predetermined diameter, and large foreign substances contained in the air discharged from the first cyclone part 113 may be filtered by the filter hole 171a.

The air passing through the filter hole 171a may be introduced into the second cyclone part 200 arranged inside the filter body 171.

At this time, the outer side and/or the outside of the filter body 171 may mean the direction facing the cyclone part 213 based on the filter body 171, and the inner side and/or the inside of the filter body 171 may mean the direction facing the second cyclone part 200 based on the filter body 171.

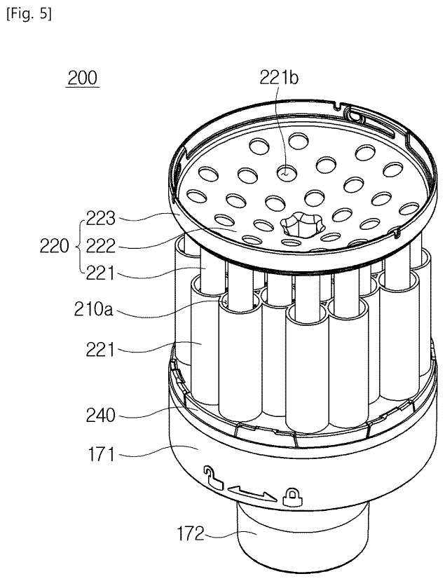

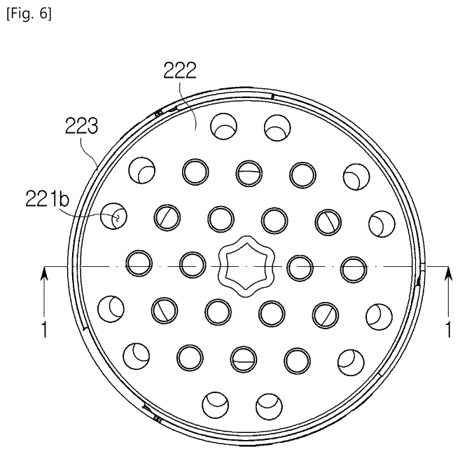

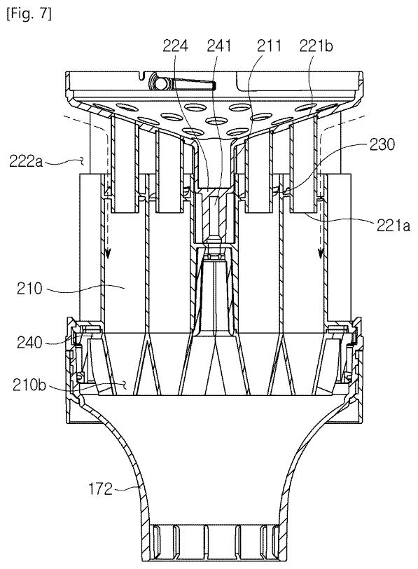

FIG. 5 is a perspective view of a second cyclone unit according to a first embodiment of the present disclosure. FIG. 6 is a plane view of FIG. 5. FIG. 7 is a cross-sectional view cut away along 1-1 line of FIG. 6.

Hereinafter, the second cyclone part of the cleaner according to the first embodiment of the present disclosure will be described with reference to FIGS. 5 to 7.

After dust is separated from the air by the first cyclone part 113, the air discharged from the first cyclone part 113 may be introduced into the second cyclone part 200 along the flow path.

The second cyclone part 200 may be arranged at least partially inside the first cyclone part 113 and can separate dust from the air discharged from the first cyclone part 113.

The second cyclone part 200 may be formed by a set of axial cyclones formed to separate dust from air flowing in the axial direction. The set of axial cyclones may include the cyclone body 210 and the dust separation part 220.

The second cyclone part 200 may include a cyclone body 210, a dust separation portion 220, and a guide vane 230.

The cyclone body 210 is configured to apply the principle of a dust collector that uses centrifugal force to separate dust from air discharged from the first cyclone part 113. A space in which air can flow may be formed inside the cyclone body 210, and air discharged from the first cyclone part 113 may be introduced into the inside of the cyclone body 210.

The cyclone body 210 may be arranged inside the filter part 170. Specifically, at least a portion of the cyclone body 210 may be disposed inside the filter body 171, and air passing through the filter hole 171a may be introduced into the inside of the cyclone body 210.

A plurality of cyclone bodies 210 may be provided. Each cyclone body 210 may be formed with an inlet 210a forming an outer wall around the hollow portion. The outer walls around the hollow portion formed by the cyclone body 210 may correspond to the outer walls of each axial cyclone. Air discharged from the first cyclone part 113 may be introduced into the inside of the cyclone body 210 through the inlet 210a. Air circulating along the inner surface of the cyclone body 210 may form a cyclone flow.

Dust heavier than air may rotate within the circulating flow while drawing a larger rotation radius than air. Since the dust rotates inside the cyclone body 210, the maximum rotation radius of the dust may be defined by the cyclone body 210.

The lower part of the cyclone body 210 may have a slanted shape that becomes narrower as it goes down. The lower portion of the cyclone body 210 has a shape that becomes narrower as it goes down to induce the falling of dust separated from the air and prevent the dust from being discharged along the air to the vortex finder 221.

The lower portion of the cyclone body 210 may be supported by a plate member 240. The plate member 240 may be arranged to surround the outer surface of each cyclone body 210. The plate member 240 may have a plurality of through holes formed at positions facing the cyclone body 210, and the lower part of the cyclone body 210 may be inserted into each of the through holes. Since the lower portion of the cyclone body 210 has an inclined shape that becomes narrower as it goes down, the cyclone body 210 may be supported by the plate member 240 at a position where the outer surface of the cyclone body 210 and the size of the through hole are the same.

The plate member 240 may have a fixing groove (not shown). The fixing groove may be arranged along the outer surface of the plate member 240, and the fixing groove may be coupled to a fixing protrusion (not shown) arranged on the inner surface of the filter body 171 so that the coupling position is set and arbitrary relative rotation is prevented. Since arbitrary relative rotation may occur between the dust separation part 220 and the filter body 171, arbitrary relative rotation must be prevented for normal operation of the second cyclone part 200.

The fixing projection of the filter body 171 is formed to be insertable into the fixing groove, and may be formed on either the plate member 240 or the filter body 171. The fixing groove of the plate member 240 is formed to accommodate the fixing projection of the filter body 171, and may be formed on the other of the plate member 240 or the filter body 171). In addition, the fixing groove of the plate member 240 and the fixing projection of the filter body 171 may be provided in multiple numbers.

An outlet 210b may be formed at the bottom of the cyclone body 210. That is, dust separated from the air inside the cyclone body 210 may be discharged from the cyclone body 210 through the outlet 210b. In addition, the bottom of the cyclone body 210 may be communicated with the internal space of the storage member 172. Therefore, dust rotating along the vortex inside the cyclone body 210 may fall and be stored in the storage member 172. The dust stored in the storage member 172 may be connected to the external space when the discharge cover 122 is opened.

The upper portion of the cyclone body 210 may be formed to accommodate the vortex finder 221. The upper portion of the cyclone body 210 may be formed to have a constant inner diameter. The upper portion and the lower portion of the cyclone body 210 may be distinguished based on the position where the inner diameter narrows.

The outer surface of each cyclone body 210 is connected to be in contact with the surrounding cyclone bodies 210, so that a plurality of cyclone bodies 210 can form one member. It is preferable that the cross section of each cyclone body 210 has a circular shape as shown in the drawing. This is because when the cross-section of the cyclone body 210 is formed in a circular shape, even if the outer surfaces of adjacent cyclone bodies 210 are in close contact with each other, a path for air and dust may be formed between them. When a path for air and dust is formed between cyclone bodies 210, there is an advantage in that a separate path structure does not need to be installed.

It is not excluded that the cross-section of each cyclone body 210 is formed as a polygon. However, even if the cross-section of each cyclone body 210 is formed as a polygon, it is preferable that it is formed as a polygon in which air and dust paths may be formed.

The dust separation part 220 may be placed on the cyclone body 210 to form a set of axial cyclones together with the cyclone body 210. The cyclone body 210 may form a part of the set, and the dust separation part 220 may form the remaining part of the set. That is, a set of axial cyclones may be formed by a plurality of cyclone bodies 210 and one member.

The dust separation part 220 may include the vortex finder 221, a band member 222, a frame member 223, and a fixing member 224. Since the dust separation part may be a single integral member, the vortex finder 221, the band member 222, the frame member 223, and the fixing member 224 may mean each part of the dust separation part 220.

The vortex finder 221 is configured to discharge air that has passed through the cyclone flow inside the cyclone body 210. A path through which air can flow may be formed inside the vortex finder 221. A plurality of vortex finders 221 may be provided, and at least a portion of each vortex finder 221 may be placed inside each cyclone body 210. The outer surface of each vortex finder 221 may be spaced apart from the inner surface of each cyclone body 210. Each vortex finder 221 has an entrance 221a forming an outer wall around the hollow portion, and air passing through the cyclone body 210 may be discharged through the inlet hole 221a of each vortex finder 221. In addition, air flowing into the inlet hole 221a may flow upward through the vortex finder 221 and be discharged through an outlet hole 221b.

The lower portion of the vortex finder 221 may have a higher height than the band member 222. However, the upper portion of the vortex finder 221 may have the same height as the band member 222. It may be seen from the drawing that the bottom of the vortex finder 221 protrudes below the dust separation part 220, but the top does not.

It is preferable that the cross section of each vortex finder 221 has a circular ring shape. It is not excluded that the cross section of each vortex finder 221 is formed as a polygon. However, even if the cross section of each vortex finder 221 is formed as a polygon, it is preferable that it is formed as a polygon in which air and dust passages may be formed.

The band member 222 may be formed to surround the outer surface of the vortex finder 221. At this time, the band member 222 may be named by another name as needed. For example, names such as ring portion, ring portion, frame portion, perimeter portion, circle portion, support portion, connection portion, outer portion, cyclone boundary portion, and outer wall portion may be considered, and other names may also be possible. The band member 222 may be mounted on the filter body 171 and may have a shape corresponding to the upper part of the filter body 171. The upper portion of the filter body 171 may be formed in a circular shape, and the band member 222 may also be formed in a circular shape that surrounds the vortex finder 221. However, this does not exclude the upper portion of the filter body 171 and the band member 222 from being formed in a polygonal shape.

The band member 222 may form a guide path 222a that guides air discharged from the first cyclone member 113 to the inside of the cyclone body 210. Here, the guide path 222a may mean a space between the band member 222 and the inlet 210a. That is, air discharged from the first cyclone member 113 and passing through the filter hole 171a may pass through the guide path 222a and be introduced into the inside of the cyclone body 210 through the inlet 210a.

The cross-sectional area of the guide path 222a may become wider from the center of the band member 222 toward the outside of the band member 222. In other words, the cross-sectional area of the guide path 222a may increase from the cyclone body 210 disposed in the center among the plurality of cyclone bodies 210 toward the outermost cyclone body 210.

The gap between the band member 222 and each inlet 210a may increase from the center of the band member 222 toward the outermost cyclone body 222. In other words, the gap between the band member 222 and each inlet 210a may increase from the cyclone body 210 disposed in the center among the plurality of cyclone bodies 210 toward the outermost cyclone body 210. Here, the gap may mean the axial gap of the cyclone body 210. Or, the gap may mean the axial gap of the vortex finder 221. Or, the above gap may mean the gap in the direction of engagement of the cyclone body 210 and the vortex finder 221.

Referring to FIG. 7, the band member 222 may be formed to slope upward from the inner side toward the outer side. That is, the gap between the band member 222 and the inlet 210a of the cyclone body 210 increases from the center of the band member 222 toward the outer side of the band member 222, so that a relatively large amount of air can be introduced into the guide path 222a. Due to this structure, the air discharged from the first cyclone part 113 may be smoothly transferred to the cyclone body 210 located in the center among the multiple cyclone bodies 210.

In addition, as the band member 222 is formed to be inclined upward, the axial length of each vortex finder 221 may gradually become longer as it is arranged from the center of the band member 222 toward the outer edge of the band member 222. In other words, the axial length of each vortex finder 221 may gradually become longer as it is arranged farther away from the fixing member 224 described later. At this time, the heights of the plurality of cyclone bodies 210 may be the same. Due to this structure, an additional downward air flow is generated along the inclined band member 222, so the amount of air flowing into the guide path 222a may increase compared to when the shape of the band member 222 is flat.

Meanwhile, the collection of axial cyclones of the cleaner according to the present invention may be formed by the flow of air passing through the cyclone body 210 and the vortex finder 221. At this time, as described above, since the length of the entire axial cyclone becomes shorter from the outer edge of the band member 222 toward the center of the band member 222, the weight of the second cyclone part 200 may be reduced.

However, if the length of the entire axial cyclone becomes shorter, the flow efficiency may decrease. At this time, if the cross-sectional area of the guide path 222a becomes narrower from the outer edge of the band member 222 toward the center of the band member 222, a relatively large amount of air may be delivered to the cyclone body 210 located at the center. Therefore, the present disclosure has the effect of increasing the efficiency of the overall axial cyclone by smoothly forming a cyclone flow up to the cyclone body 210 located at the center.

The position fixing step (not shown) of the dust separation part 220 may be set by fitting into the step (not shown) of the filter body 171 so that the joining position is set and arbitrary relative rotation is prevented. Since arbitrary relative rotation may occur between the dust separation part 220 and the filter body 171, arbitrary relative rotation must be prevented for normal operation of the second cyclone part 200.

The fixing member 224 may be provided in the band member 222 to fix the plate member 240 to the band member 222. The fixing member 224 may be arranged on the lower surface of the band member 222. The fixing member 224 may extend downward from the center of the lower surface of the band member 222.

The fixing member 224 may be fitted into the fixing space 211. The fixing space 211 may be formed by cyclone bodies 210 located at the center among a plurality of cyclone bodies 210. That is, among the plurality of cyclone bodies 210, the outer peripheral surfaces of the cyclone bodies 210 located at the center are connected to be in contact with the surrounding cyclone bodies 210, so that the fixing space 211 is surrounded by the outer peripheral surfaces of the cyclone bodies 210 located at the center.

The fixing space 211 may be formed to correspond to the fixing member 224. In a state where the fixing member 224 is fitted into the fixing space 211, the plurality of cyclone bodies 210 may be arranged radially with the fixed member 224 as the center. At this time, the axial length of each vortex finder 221 may gradually increase as it is arranged farther away from the fixing member 224. The fixing member 224 fitted into the fixing space 211 is fitted into the position fixing projection 241 formed on the upper surface of the plate member 240 to set the joining position, and may prevent arbitrary relative rotation between the dust separation part 220 and the cyclone body 210.

The frame member 223 may be formed to surround the band member 222 to form a frame of the dust separation part 220. The frame member 223 may surround the band member 222 at the outer edge of the band member 222. Meanwhile, the frame member 223 may form a fixed step together with the band member 222. That is, since a portion of the side surface of the band member 222 and the lower surface of the frame member 223 form the fixed step, the filter body 171 may be fitted into the fixed step.

The protruding member (not shown) may be formed on the upper surface where the outlet hole 221b of the vortex finder 221 is arranged to guide the air discharged through the outlet hole 221b in a certain direction. At this time, the upper portion of the protruding member may have the same height as the frame member 223, and the lower portion of the protruding member may have the same height as the band member 222. Since the protruding member has the same height as the frame member 223 and the band member 222, the possibility of interference with other parts and the possibility of damage can be reduced.

Since the vortex finder 221 and the band member 222 are connected to each other, and the band member 222 is connected to the frame member 223, the dust separation part 220 may be formed as a single integral member.

The guide vane 230 is configured to guide air discharged from the first cyclone part 113 to the inside of the cyclone body 210. The guide vane 230 may form a path through which air introduced through the inlet 210a may flow into the inside of the cyclone body 210. Therefore, air flowing along the path formed by the guide vane 230 may form a swirling flow between the vortex finder 221 and the cyclone body 210.

At least a portion of the guide vane 230 may be arranged between the cyclone body 210 and the vortex finder 221 and connected to each cyclone body 210 and each vortex finder 221. One side of the guide vane 230 may be connected to the outer surface of the vortex finder 221 along the spiral direction, and the other side of the guide vane 230 may be connected to the inner surface of the cyclone body 210 along the spiral direction.

Each cyclone body 210 and each vortex finder 221 may be provided with a plurality of guide vanes 230, and the guide vanes 230 may extend in a spiral direction to generate a swirling flow. As the guide vanes 230 extend in a spiral direction, air and dust flowing into the inlet 210a of the cyclone body 210 may form a swirling flow.

Hereinafter, the flow of air flowing through the air passage of the cleaner according to the first embodiment of the present invention will be described.

First, when the suction motor 114 is operated, external air may be introduced into the interior of the dust bin 120 through the suction port 112.

Air separated from dust by the first cyclone part 113 inside the dust bin 120 may pass through the filter hole 171a formed in the filter body 171 and flow into the passage between the cyclone body 210 and the filter body 171. At this time, the passage between the cyclone body 210 and the filter body 171 may be formed between the outer surface of the cyclone body 210 and the inner surface of the filter body 171.

Air passing through the filter hole 171a may pass through the passage between the cyclone body 210 and the filter body 171 and then flow into the inside of the cyclone body 210 through the inlet 210a of the cyclone body 210.

Air drawn into the inside of the cyclone body 210 may flow upwards and pass through the vortex finder 221 after forming a swirling flow and falling. Air that has passed through the vortex finder 221 may flow toward the suction motor 114 and be discharged to the outside through the HEPA filter and air exhaust port.

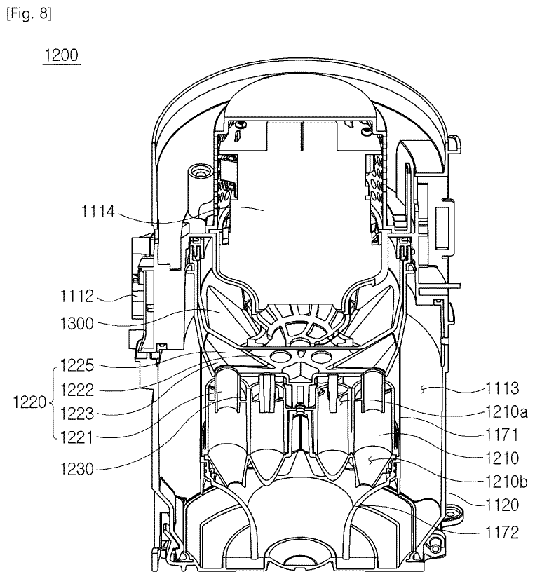

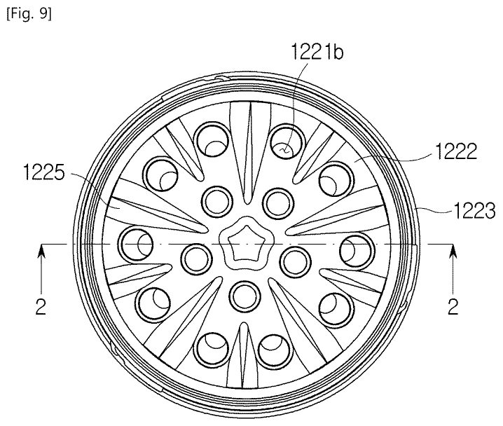

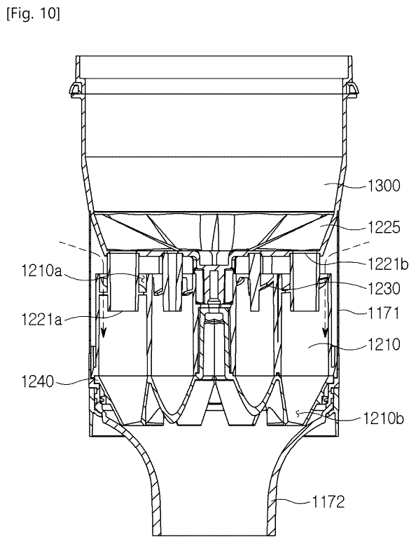

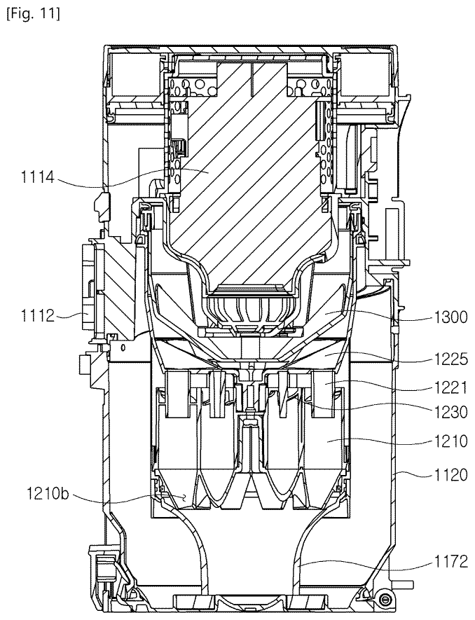

FIG. 8 is a perspective view of a second cyclone unit according to a second embodiment of the present disclosure. FIG. 9 is a plane view of FIG. 8. FIG. 10 is a cross-sectional view cut away along 2-2 line of FIG. 9. FIG. 11 is a diagram to describe the shape of a filter according to a second embodiment of the present disclosure.

Hereinafter, the second cyclone part of the cleaner according to the second embodiment of the present invention will be described with reference to FIGS. 8 to 11.

Meanwhile, the second embodiment of the present disclosure is the same as the first embodiment in other parts, but has differences in the second cyclone part 1200 and the filter 1300. Therefore, only the characteristic parts of the second embodiment will be described below, and the same parts as the first embodiment will be referred to the first embodiment.

Referring to FIGS. 8 to 11, in the second embodiment of the present invention, the band member 1222 may be arranged to surround the outer surface of each vortex finder 1221. At this time, the gap between the band member 1222 and each inlet 1210a may be the same.

The frame member 1223 is formed to surround the band member 1222 and may guide air discharged from the first cyclone part 1113 together with the band member 1222 to the inside of each cyclone body 1210. The gap between the frame member 1223 and each inlet 1210a may increase from the inside of the frame member 1223 toward the outside. The frame member 1223 can be formed to slope upward from the inside toward the outside.

The second cyclone part 1200 may further include a protruding member 1225. The protruding member 1225 is arranged on the upper side of the band member 1222 and may guide air passing through the vortex finder 1221 to flow upward toward the suction motor 1114. That is, the protruding member 1225 serves to guide the air discharged through the outlet 1221b of the vortex finder 1221 to flow in a certain direction.

The cleaner according to the second embodiment of the present invention may further include a filter 1300 that filters air. The filter 1300 may include a pre-filter that filters the air before the air passing through the vortex finder 1221 is sucked in by the suction motor 1114.

The filter 1300 may be placed on the upper side of the protruding member 1225. The filter 1300 may be supported by the protruding member 1225. The shape of the filter 1300 may correspond to the shape of the protruding member 1225. For example, if the protruding member 1225 is formed to slope upwardly toward the outside from the center of the band member 1222, the lower shape of the filter 1300 may also be formed to slope upwardly toward the outside from the center of the band member 1222.

In addition, the height of the filter 1300 may be changed according to the height of the protruding member 1225, so that as the height of the protruding member 1225 increases, the height of the filter 1300 may decrease.

Hereinafter, the flow of air flowing through the air passage of the cleaner according to the second embodiment of the present disclosure will be described.

First, when the suction motor 1114 is operated, external air may be introduced into the interior of the dust bin 1120 through the suction part 1112.

Air from which dust is separated by the first cyclone part 1113 inside the dust bin 1120 may pass through the filter hole formed in the filter body 1171 and be introduced into the passage between the cyclone body 1210 and the filter body 1171. At this time, the passage between the cyclone body 1210 and the filter body 1171 may be formed between the outer surface of the cyclone body 1210 and the inner surface of the filter body 1171.

Air passing through the filter hole may pass through the path between the cyclone body 1210 and the filter body 1171 and then flow into the inlet 1210a of the cyclone body 1210 and flow into the inside of the cyclone body 1210.

Air flowing into the inside of the cyclone body 1210 and flowing along the guide vane 1230 may fall while forming a swirling flow and then flow upward and pass through the vortex finder 1221. Each vortex finder 1221 has an inlet hole 1221a forming an outer wall around the hollow portion, and air passing through the cyclone body 1210 may be discharged through the inlet hole 1221a of each vortex finder 1221. Additionally, air drawn into the inlet hole 1221a may flow upward through the vortex finder 221 and be discharged through the outlet hole 1221b. Air passing through the vortex finder 1221 may flow toward the suction motor 1114 and be discharged to the outside through the HEPA filter and the air exhaust port.

Dust separated from the inside of the cyclone body 1210 may be discharged through the outlet 1210b. Dust discharged through the outlet 1210b may be stored in the internal space of a storage member 1172 extending downwardly from the filter body 1171.

Although the present invention has been described with reference to the exemplified drawings, it is to be understood that the present invention is not limited to the embodiments and drawings disclosed in this specification, and those skilled in the art will appreciate that various modifications are possible without departing from the scope and spirit of the present invention.

Further, although the operating effects according to the configuration of the present invention are not explicitly described while describing an embodiment of the present invention, it should be appreciated that predictable effects are also to be recognized by the configuration.

1. A cleaner comprising:
a suction port configured to guide air into a dust bin;
a first cyclone part configured to separate dust from air sucked in through the suction port; and
a second cyclone part configured to separate dust from air discharged from the first cyclone part,
wherein the second cyclone part comprises,
a plurality of cyclone bodies each having an inlet configured to receive air discharged from the first cyclone part;
a vortex finder having at least a portion disposed on the inside of each cyclone body; and
a band member disposed to surround an outer surface of each vortex finder and configured to guide air discharged from the first cyclone part to the inside of each cyclone body, and
the gap between the band member and each inlet increases from the center of the band member toward the periphery of the above band member.

2. A cleaner comprising:
a suction port configured to guide air into a dust bin;
a first cyclone part configured to separate dust from air sucked through the suction port; and
a second cyclone part configured to separate dust from air discharged from the first cyclone part,
wherein the second cyclone part comprises,
a plurality of cyclone bodies each forming an outer wall around a hollow portion;
a vortex finder having at least portion disposed on the inner side of each cyclone body; and
a band member disposed to surround an outer surface of each vortex finder and configured to form a guide path to guide air discharged from the first cyclone part to the inner side of each cyclone body, and
the cross-sectional area of the guide path increases from the center of the band member toward the outside of the band member.

3. The cleaner of claim 1, wherein the band member is formed with an upward slope from the inside to the outside.

4. The cleaner of claim 1, wherein the second cyclone part further comprises,
a plate member arranged to surround an outer surface of each cyclone body; and
a fixing member configured to fix the plate member to the band member, and
the plurality of cyclone bodies are arranged radially around the fixing member.

5. The cleaner of claim 4, wherein the axial length of each vortex finder gradually increases as it is positioned farther away from the fixed member.

6. The cleaner of claim 1, wherein the heights of the cyclone bodies are the same.

7. A cleaner comprising:
a suction port configured to guide air into a dust bin;
a first cyclone part configured to separate dust from air sucked in through the suction port; and
a second cyclone part configured to separate dust from air discharged from the first cyclone part,
wherein the second cyclone part comprises,
a plurality of cyclone bodies each having an inlet configured to receive air discharged from the first cyclone part;
a vortex finder having at least a portion disposed on the inside of each cyclone body;
a band member disposed to surround an outer surface of each vortex finder and configured to guide air discharged from the first cyclone part to the inside of each cyclone body; and
a frame member formed to surround the band member and configured to guide air discharged from the first cyclone part together with the band member to the inside of each cyclone body, and
the gap between the frame member and each inlet increases from the inside to the outside of the frame member.

8. The cleaner of claim 7, wherein the frame member is formed with an upward slope from the inside to the outside.

9. The cleaner of claim 7, wherein the gap between the band member and each inlet is the same.

10. The cleaner of claim 7, wherein the second cyclone part further comprises,
a protruding member disposed on an upper side of the band member and configured to guide air passing through the vertex finder to flow upward.
